(19) United States
(12) Patent Application Publication
(10) Pub. No.: US 2026/0196698 A1
(43) Pub. Date: Jul. 9, 2026

(54) POWER STORAGE DEVICE

(71) Applicant: TOYOTA JIDOSHA KABUSHIKI KAISHA, Toyota-shi (JP)

(72) Inventor: Shintaro TOMITA, Obu-shi (JP)

(73) Assignee: TOYOTA JIDOSHA KABUSHIKI KAISHA, Toyota-shi (JP)

(21) Appl. No.: 19/403,950

(22) Filed: Nov. 30, 2025

(30) Foreign Application Priority Data
Jan. 8, 2025 (JP) 2025-002920

(51) Int. Cl. H01M 50/588; H01M 50/209; H01M 50/249; H01M 50/262; B60L 50/64

(52) U.S. Cl. CPC H01M 50/588; H01M 50/209; H01M 50/249; H01M 50/262; B60L 50/64; H01M 2220/20

(57) ABSTRACT

In a power storage device, a first cell terminal faces a second battery module. A first restraining member is provided on a first cell case of each of first cells so as to apply a restraining load to the first cells in the second direction, A second cell terminal faces a first battery module. A second restraining member is provided on a second cell case of each of second cells so as to apply a restraining load to the second cells in the second direction. The first restraining member and the second restraining member are connected to each other upward from the first cell terminals of the first cells and also upward from the second cell terminals of the second cells, so as to close off between the first cells and the second cells.

### CROSS-REFERENCE TO RELATED APPLICATION

This application claims priority to Japanese Patent Application No. 2025-002920 filed on January 8, 2025. The disclosure of the above-identified application, including the specification, drawings, and claims, is incorporated by reference herein in its entirety.

### BACKGROUND

### Technical Field

### The present disclosure relates to a power storage device.

### Description of Related Art

Japanese Unexamined Patent Application Publication No. 2020-149934 (JP 2020-149934 A) discloses a conventional battery module. This battery module includes a plurality of secondary batteries and a lower-side insulating member. The secondary batteries are arrayed in a side-by-side direction. Each of the secondary batteries has a pressure release valve. The lower-side insulating member has partition portions that cover all of the pressure relief valves that are arrayed in the side-by-side direction. An exhaust passage is formed between the partition portions and an outer face of a lid portion of each of the secondary batteries. The exhaust passage is provided for the flow of gases released from the pressure relief valves when opened. The secondary batteries are restrained from both sides in the side-by-side direction by a pair of end plates, by screwing nuts onto through-bolts. The through bolts and the nuts make up a restraining member.

### SUMMARY

In an abnormal mode of a power storage device equipped with a battery module, electrically conductive foreign matter (debris) consisting of fragments of cases of the secondary batteries or part of contents of the cases may be scattered from portions from which gases are released, as the gas is discharged. In battery modules, there is a need to suppress such debris from coming into contact with terminals of cells and causing short-circuiting. On the other hand, there also is a need to reduce the number of members in the power storage device, in order to provide a more inexpensive power storage device.

The present disclosure has been made in light of the above problems, and an object thereof is to provide a power storage device that can suppress debris from coming into contact with cell terminals, while suppressing increase in the number of members.

A power storage device according to an aspect of the present disclosure includes a first battery module and a second battery module. The second battery module is situated in a first direction perpendicular to an up-down direction as viewed from the first battery module. The first battery module includes a plurality of first cells and a first restraining member. The first cells are aligned in a second direction that is perpendicular to both the up-down direction and the first direction. Each of the first cells includes a first cell case and a first cell terminal. The first cell terminal is provided on the first cell case and also faces the second battery module. the first restraining member is provided on the first cell case of each of the first cells so as to apply a restraining load to the first cells in the second direction, The second battery module includes a plurality of second cells and a second restraining member. The second cells are aligned in the second direction. Each of the second cells includes a second cell case and a second cell terminal. The second cell terminal is provided on the second cell case and also faces the first battery module. The second restraining member is provided on the second cell case of each of the second cells so as to apply a restraining load to the second cells in the second direction. The first restraining member and the second restraining member are connected to each other upward from the first cell terminals of the first cells and also upward from the second cell terminals of the second cells, so as to close off between the first cells and the second cells.

According to the present disclosure, debris can be suppressed from coming into contact with the cell terminals, while suppressing increase in the number of members.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a vehicle equipped with a power storage device according to an embodiment of the present disclosure;

FIG. 2 is a perspective view illustrating a first battery module and a second battery module, in a state of being accommodated in a case;

FIG. 3 is a cross-sectional view of the first battery module and the second battery module in FIG. 2, as viewed in a direction of arrows along line III-III;

FIG. 4 is a cross-sectional view illustrating a power storage device according to a modification; and

FIG. 5 is a cross-sectional view illustrating a power storage device according to yet another modification.

### DETAILED DESCRIPTION OF EMBODIMENTS

Hereinafter, a power storage device according to an embodiment of the present disclosure will be described with reference to the drawings. The same reference signs denote the same or equivalent portions in the drawings, and the description of such portions will not be repeated. Each drawing also includes symbols "U", "D", and "D1" to "D4", which indicate directions for describing a configuration of the power storage device. "U" indicates upward, "D" indicates downward, and "D1", "D2", "D3" and "D4" indicate a first direction, a second direction, a third direction, and a fourth direction, respectively. The first direction is a direction perpendicular to an up-down direction. The second direction is a direction perpendicular to both the up-down direction and the first direction. The third direction is an opposite direction to the first direction. The fourth direction is an opposite direction to the second direction.

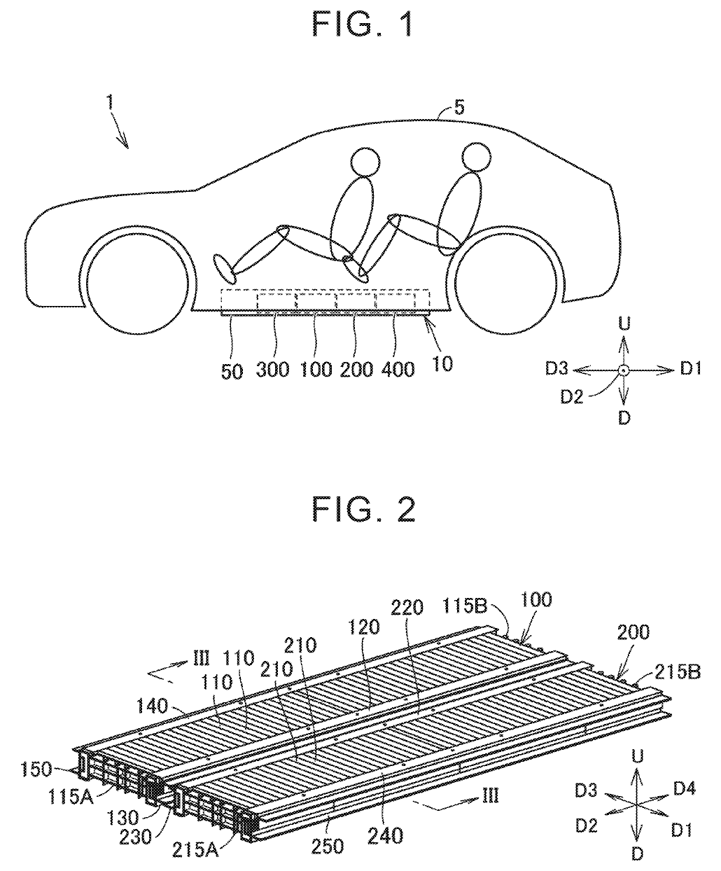

FIG. 1 is a diagram schematically illustrating a vehicle equipped with the power storage device according to the embodiment of the present disclosure. As illustrated in FIG. 1, a vehicle 1 includes a vehicle frame 5 and a power storage device 10. The power storage device 10 is installed in the vehicle 1 by being fixed to the vehicle frame 5. The vehicle 1 may be, for example, a battery electric vehicle such as a plug-in hybrid battery electric vehicle (PHEV), a battery electric vehicle (BEV), or the like. The vehicle 1 is driven by electric power supplied from the power storage device 10.

Note that in the present embodiment, the first direction in the power storage device 10 corresponds to rearward in the vehicle 1, but may correspond to another direction. That is to say, the first direction in the power storage device 10 may be forward, rightward, or leftward in the vehicle 1.

The power storage device 10 according to the embodiment of the present disclosure includes a case 50, a first battery module 100, a second battery module 200, a third battery module 300, and a fourth battery module 400. The case 50 is fixed to the vehicle frame 5. The case 50 accommodates the first battery module 100, the second battery module 200, the third battery module 300, and the fourth battery module 400. The case 50 is also called a battery pack.

From a perspective of improving energy density of the power storage device 10, the proportion of the volume occupied by each of the battery modules within the case 50 is preferably large. However, when the proportion of this volume is large, and debris (described in detail later) is generated in an abnormal mode of the power storage device 10, space in which the debris can accumulate within the case 50 becomes small. As a result, the debris can be more likely to reach members of the battery module that are situated at portions far from the point of origin.

The second battery module 200 is situated in the first direction as viewed from the first battery module 100. No other battery module is situated between the second battery module 200 and the first battery module 100. The third battery module 300 is situated in the third direction as viewed from the first battery module 100. The fourth battery module 400 is situated in the first direction as viewed from the second battery module 200.

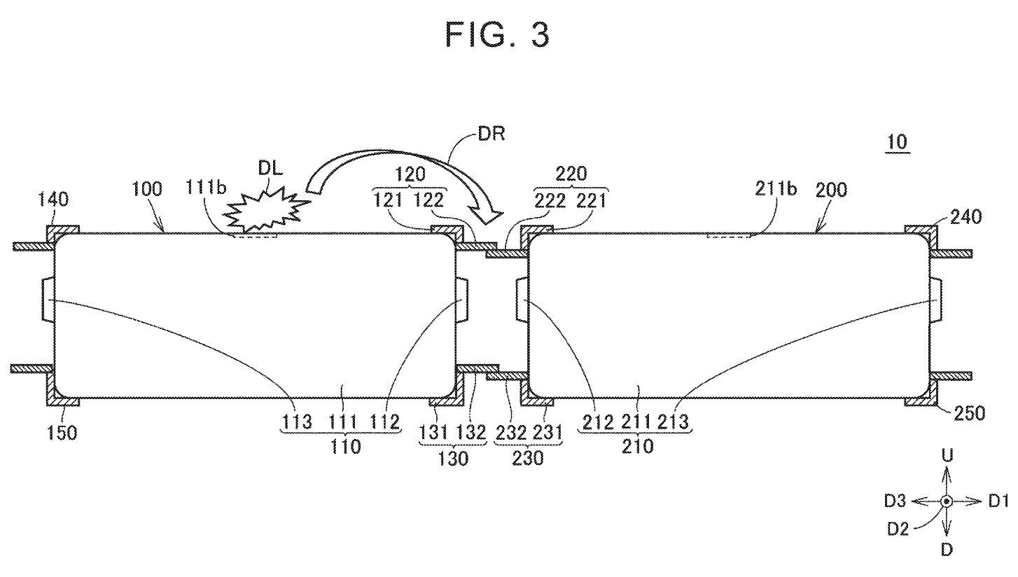

The first battery module 100 will be described in detail. FIG. 2 is a perspective view illustrating the first battery module and the second battery module accommodated in the case. FIG. 3 is a cross-sectional view of the first battery module and the second battery module in FIG. 2, as viewed in a direction of arrows along line III-III.

As illustrated in FIGS. 2 and 3, the first battery module 100 includes a plurality of first cells 110, a first end plate 115A, a first other end plate 115B, a first restraining member 120, a first lower-side restraining member 130, a first other restraining member 140, and a first other lower-side member restraining member 150.

The first cells 110 are aligned in the second direction. Each of the first cells 110 may be a secondary battery such as a lithium-ion secondary battery, a nickel metal hydride battery, or the like.

Each of the first cells 110 includes a first cell case 111, a first cell terminal 112, and a first other cell terminal 113. The first cell case 111 accommodates an electrode assembly and an electrolytic solution (both omitted from illustration). In the electrode assembly, a cathode and an anode are stacked together with a separator interposed therebetween. The first cell case 111 has a substantially rectangular cuboid outer shape. Accordingly, the first cell 110 is a so-called prismatic cell. A first exhaust valve 111b is formed on an upper face of the first cell case 111. However, the location where the first exhaust valve 111b is formed is not limited to the upper face of the first cell case 111.

The first cell terminal 112 is provided on the first cell case 111 and also faces the second battery module 200. The location where the first other cell terminal 113 is provided is not limited in particular. One of the first cell terminal 112 and the first other cell terminal 113 is electrically connected to the cathode accommodated in the first cell case 111, and the other is electrically connected to the anode accommodated in the first cell case 111.

The first end plate 115A is situated on a distal end side in the second direction as viewed from the first cells 110. The first other end plate 115B is situated on a distal end side in the fourth direction as viewed from the first cells 110.

The first restraining member 120, the first lower-side restraining member 130, the first other restraining member 140, and the first other lower-side member restraining member 150 are provided on the first cell case 111 of each of the first cells 110, so as to apply a restraining load to the first cells 110 in the second direction. Specifically, the first restraining member 120, the first lower-side restraining member 130, the first other restraining member 140, and the first other lower-side member restraining member 150 may be fastened to the first end plate 115A and the first other end plate 115B, such that the first end plate 115A applies a load to the first cells 110 in the fourth direction, and the first other end plate 115B applies a load to the first cells 110 in the second direction. These restraining members may be made of metal. These restraining members may be made substantially of metal alone.

The first restraining member 120 includes a first restraining main body portion 121 and a first rib 122. The first restraining main body portion 121 extends along surfaces of the first cell cases 111 of the first cells 110. Specifically, the first restraining main body portion 121 extends along an upward corner portion of the first cell cases 111.

The first rib 122 extends in parallel to the first direction from the first restraining main body portion 121. Specifically, the first rib 122 extends from a portion of the first restraining main body portion 121 that is situated to the side thereof (first direction) as viewed from the first cell cases 111.

The first lower-side restraining member 130 includes a first lower-side restraining main body portion 131 and a first lower-side rib 132. The first lower-side restraining main body portion 131 extends along the surface of the first cell cases 111 of the first cells 110. Specifically, the first lower-side restraining main body portion 131 extends along a downward corner portion of the first cell cases 111.

The first lower-side rib 132 extends in parallel to the first direction from the first lower-side restraining main body portion 131. Specifically, the first lower-side rib 132 extends from a portion of the first lower-side restraining main body portion 131 that is located to the side (first direction) as viewed from the first cell case 111.

The first other restraining member 140 is disposed symmetrically as to the first restraining member 120 in a lateral direction as viewed from the first cells 110. The first other restraining member 140 may have a configuration symmetrical to the first restraining member 120 in the lateral direction as viewed from the first cells 110.

The first other lower-side member restraining member 150 is disposed symmetrically to the first lower-side restraining member 130 in the lateral direction as viewed from the first cells 110. The first other lower-side member restraining member 150 may have a configuration symmetrical to the first lower-side restraining member 130 in the lateral direction as viewed from the first cells 110.

The second battery module 200 includes a plurality of second cells 210, a second end plate 215A, a second other end plate 215B, a second restraining member 220, a second lower-side restraining member 230, a second other restraining member 240, and a second other lower-side restraining member 250. With the exception of some configurations, these each have the same configurations as the first cells 110, the first end plate 115A, the first other end plate 115B, the first restraining member 120, the first lower-side restraining member 130, the first other restraining member 140, and the first other lower-side member restraining member 150, in the first battery module 100. Accordingly, descriptions of similar configurations may not be repeated in some cases.

Each of the second cells 210 includes a second cell case 211, a second cell terminal 212, and a second other cell terminal 213. These correspond to the first cells 110, the first cell terminal 112, and the first other cell terminal 113 in each of the first cells 110.

A second exhaust valve 211b is formed on an upper face of the second cell case 211. However, the location where the second exhaust valve 211b is formed is not limited to the upper face of the second cell case 211. The second cell terminal 212 faces the first battery module 100.

The second restraining member 220 includes a second restraining main body portion 221 and a second rib 222. The second restraining main body portion 221 extends along surfaces of the second cell cases 211 of the second cells 210. Specifically, the second restraining main body portion 221 extends along an upward corner portion of the second cell cases 211.

The second rib 222 extends in parallel to the third direction from the second restraining main body portion 221. Specifically, the second rib 222 extends from a portion of the second restraining main body portion 221 that is situated to the side thereof (third direction) as viewed from the second cell cases 211.

The second lower-side restraining member 230 includes a second lower-side restraining main body portion 231 and a second lower-side rib 232. The second lower-side restraining main body portion 231 extends along the surface of the second cell cases 211 of the second cells 210. Specifically, the second lower-side restraining main body portion 231 extends along a downward corner portion of the second cell cases 211.

The second lower-side rib 232 extends in parallel to the third direction from the second lower-side restraining main body portion 231. Specifically, the second lower-side rib 232 extends from a portion of the second lower-side restraining main body portion 231 that is located to the side thereof (third direction) as viewed from the second cell cases 211.

The second other restraining member 240 is disposed symmetrically to the second restraining member 220 in the lateral direction as viewed from the second cells 210. The second other restraining member 240 may have a configuration symmetrical to the second restraining member 220 in the lateral direction as viewed from the second cells 210.

The second other lower-side restraining member 250 is disposed symmetrically to the second lower-side restraining member 230 in the lateral direction as viewed from the second cells 210. The second other lower-side restraining member 250 may have a configuration symmetrical to the second lower-side restraining member 230 in the lateral direction as viewed from the second cells 210.

Here, the first restraining member 120 and the second restraining member 220 are connected to each other upward from the first cell terminals 112 of the first cells 110 and also upward from the second cell terminals 212 of the second cells 210, so as to close off between the first cells 110 and the second cells 210. In the present embodiment, the first rib 122 and the second rib 222 are in contact with each other in the up-down direction between the first cells 110 and the second cells 210. The first restraining member 120 and the second restraining member 220 are joined to each other by laser welding or the like. However, the first restraining member 120 and the second restraining member 220 do not have to be joined to each other.

Further, the first lower-side restraining member 130 and the second lower-side restraining member 230 are connected to each other downward from the first cell terminals 112 of the first cells 110 and also downward from the second cell terminals 212 of the second cells 210, so as to close off space between the first cells 110 and the second cells 210. In the present embodiment, the first lower-side rib 132 and the second lower-side rib 232 are in contact with each other in the up-down direction between the first cells 110 and the second cells 210. The first lower-side restraining member 130 and the second lower-side restraining member 230 are joined to each other by laser welding or the like. However, the first lower-side restraining member 130 and the second lower-side restraining member 230 do not have to be joined to each other.

Note that the form by which the first restraining member 120 and the second restraining member 220 are connected, and the form by which the first lower-side restraining member 130 and the second lower-side restraining member 230 are connected, are not limited to the above.

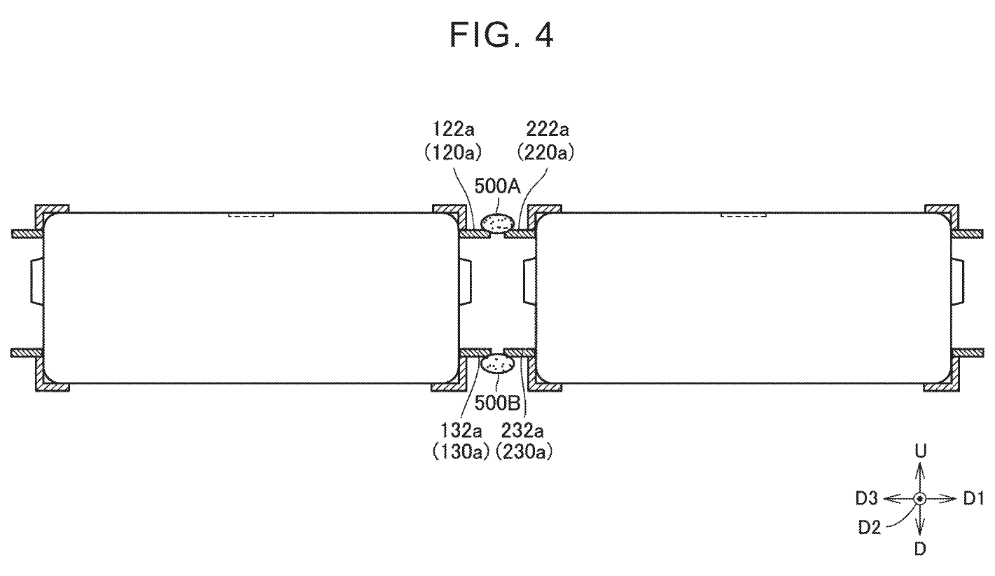

FIG. 4 is a cross-sectional view illustrating a power storage device according to a modification. The cross-sectional view of the modification illustrated in FIG. 4 corresponds to the cross-sectional view of the embodiment illustrated in FIG. 3.

As illustrated in FIG. 4, the first rib 122a of the first restraining member 120a and the second rib 222a of the second restraining member 220a may be aligned in the first direction. A gap may be formed between the first rib 122a of the first restraining member 120a and the second rib 222a of the second restraining member 220a, but the gap can be filled with a first filler 500A, which is a material that is different from the first restraining member 120a and the second restraining member 220a. That is to say, the first rib 122a of the first restraining member 120a and the second rib 222a of the second restraining member 220a may be connected to each other by the first filler 500A.

The first lower-side rib 132a of the first lower-side restraining member 130a and the second lower-side rib 232a of the second lower-side restraining member 230a may be aligned in the first direction. A gap may be formed between the first lower-side rib 132a of the first lower-side restraining member 130a and the second lower-side rib 232a of the second lower-side restraining member 230a, but the gap is filled with a second filler 500B, which is a material that is different from the first lower-side restraining member 130a and the second lower-side restraining member 230a. That is to say, the first lower-side rib 132a of the first lower-side restraining member 130a and the second lower-side rib 232a of the second lower-side restraining member 230a may be connected to each other by the second filler 500B.

The first filler 500A and the second filler 500B may be, for example, an adhesive or a sealant.

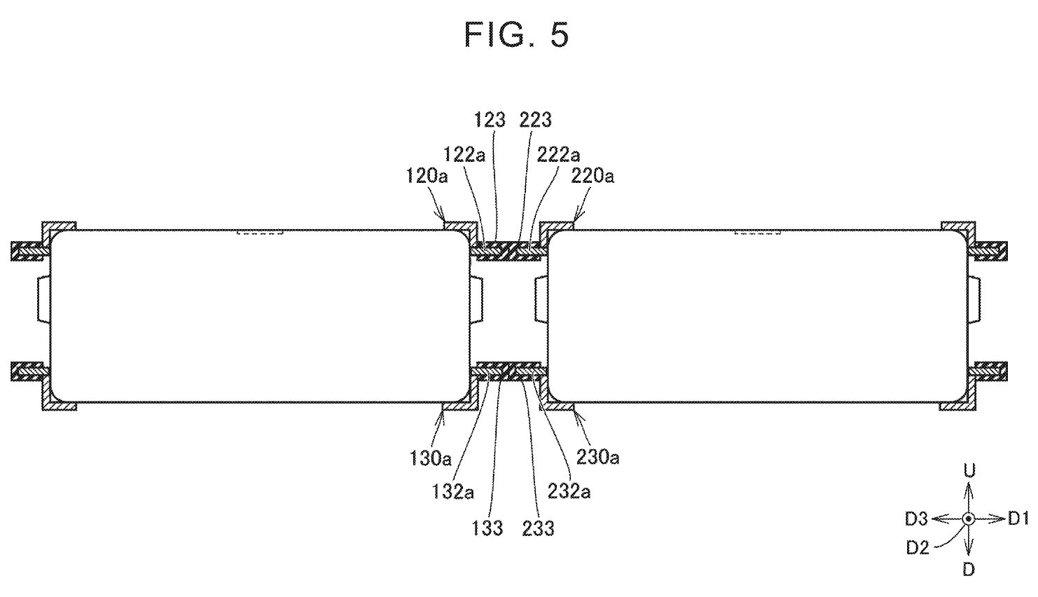

FIG. 5 is a cross-sectional view illustrating a power storage device according to yet another modification. The cross-sectional view of the other modification illustrated in FIG. 5 corresponds to the cross-sectional view of the modification illustrated in FIG. 4. As illustrated in FIG. 5, the first restraining member 120a, the first lower-side restraining member 130a, the second restraining member 220a, and the second lower-side restraining member 230a may further include a first covering material 123, a first lower-side covering material 133, a second covering material 223, and a second lower-side covering material 233, respectively. The first covering material 123, the first lower-side covering material 133, the second covering material 223, and the second lower-side covering material 233 cover a first rib 122a, a first lower-side rib 132a, a second rib 222a, and a second lower-side rib 232a, respectively. These coating materials may be electrically insulating.

As illustrated in this other modification, an arrangement may be made in which the first covering material 123 and the second covering material 223 abut each other, such that the first rib 122a of the first restraining member 120a and the second rib 222a of the second restraining member 220a are connected to each other. An arrangement may also be made in which the first lower-side covering material 133 and the second lower-side covering material 233 abut each other, such that the first lower-side rib 132a of the first lower-side restraining member 130a and the second lower-side rib 232a of the second lower-side restraining member 230a are connected to each other.

As described above, the power storage device 10 according to the embodiment of the present disclosure includes the first battery module 100 and the second battery module 200. The second battery module 200 is situated in the first direction perpendicular to the up-down direction as viewed from the first battery module 100. The first battery module 100 includes the first cells 110 and the first restraining member 120. The first cells 110 are aligned in the second direction that is perpendicular to both the up-down direction and the first direction. Each of the first cells 110 includes the first cell case 111 and the first cell terminal 112. The first cell terminal 112 is provided on the first cell case 111 and also faces the second battery module 200. The first restraining member 120 is provided on the first cell case 111 of each of the first cells 110 so as to apply the restraining load to the first cells 110 in the second direction. The second battery module 200 includes the second cells 210 and the second restraining member 220. The second cells 210 are aligned in the second direction. Each of the second cells 210 includes the second cell case 211 and the second cell terminal 212. The second cell terminal 212 is provided on the second cell case 211 and also faces the first battery module 100. The second restraining member 220 is provided on the second cell case 211 of each of the second cells 210 so as to apply the restraining load to the second cells 210 in the second direction. The first restraining member 120 and the second restraining member 220 are connected to each other upward from the first cell terminals 112 of the first cells 110 and also upward from the second cell terminals 212 of the second cells 210, so as to close off between the first cells 110 and the second cells 210.

In an abnormal mode of the power storage device 10, when gas is discharged from inside the first cell cases 111 or the second cell cases 211 to the upper side thereof, electrically conductive foreign matter (debris) consisting of fragments of the cases or part of contents of the cases may be scattered at the upper side of the cases, as the gas is discharged. In FIG. 3, an example of the location where debris is generated and a scattering route thereof are indicated by the symbols "DL" and "DR", respectively. Here, connecting the first restraining member 120 and the second restraining member 220 to each other, as configured above, suppresses such debris from coming into contact with the first cell terminals 112 or the second cell terminals 212. Accordingly, debris can be suppressed from coming into contact with the cell terminals while suppressing an increase in the number of members.

Also, in the present embodiment, the first restraining member 120 includes the first restraining main body portion 121 and the first rib 122. The first restraining main body portion 121 extends along surfaces of the first cell cases 111 of the first cells 110. The first rib 122 extends in parallel to the first direction from the first restraining main body portion 121. The second restraining member 220 includes the second restraining main body portion 221 and the second rib 222. The second restraining main body portion 221 extends along the surfaces of the second cell cases 211 of the second cells 210. The second rib 222 extends from the second restraining main body portion 221 in parallel to the third direction that is the opposite direction to the first direction. The first rib 122 and the second rib 222 are in contact with each other in the up-down direction between the first cells 110 and the second cells 210.

According to the above configuration, the first rib 122 extends relatively longer from the first restraining main body portion 121 in the first direction. For example, in comparison with the above-described modifications, the first rib 122 according to the present embodiment is longer in the first direction. This further improves rigidity of the first restraining main body portion 121. The second rib 222 also extends relatively longer from the second restraining main body portion 221 in the third direction. For example, in comparison with the above-described modifications, the second rib 222 according to the present embodiment is longer in the third direction. This further improves rigidity of the second rib 222.

Also, in the present embodiment, the first battery module 100 further includes the first lower-side restraining member 130. The first lower-side restraining member 130 is provided on the first cell case 111 of each of the first cells 110 so as to apply the restraining load to the first cells 110 in the second direction. The second battery module 200 further includes the second lower-side restraining member 230. The second lower-side restraining member 230 is provided on the second cell case 211 of each of the second cells 210 so as to apply the restraining load to the second cells 210 in the second direction. The first lower-side restraining member 130 and the second lower-side restraining member 230 are connected to each other downward from the first cell terminals 112 of the first cells 110 and also downward from the second cell terminals 212 of the second cells 210, so as to close off between the first cells 110 and the second cells 210.

According to the above configuration, the first lower-side restraining member 130 and the second lower-side restraining member 230 can suppress debris from coming into contact with the first cell terminals 112 and the second cell terminals 212 from the lower side of the first cell terminals 112 or the second cell terminals 212.

Also, in the present embodiment, the first lower-side restraining member 130 includes the first lower-side restraining main body portion 131 and the first lower-side rib 132. The first lower-side restraining main body portion 131 extends along the surfaces of the first cell cases 111 of the first cells 110. The first lower-side rib 132 extends in parallel to the first direction from the first lower-side restraining main body portion 131. The second lower-side restraining member 230 includes the second lower-side restraining main body portion 231 and the second lower-side rib 232. The second lower-side restraining main body portion 231 extends along the surfaces of the second cell cases 211 of the second cells 210. The second lower-side rib 232 extends from the second lower-side restraining main body portion 231 in parallel to the third direction that is the opposite direction to the first direction. The first lower-side rib 132 and the second lower-side rib 232 are in contact with each other in the up-down direction between the first cells 110 and the second cells 210.

According to the above configuration, the first lower-side rib 132 extends relatively longer from the first lower-side restraining main body portion 131 in the first direction. For example, in comparison with the above-described modifications, the first lower-side rib 132 according to the present embodiment is longer in the first direction. This further improves rigidity of the first lower-side restraining main body portion 131. Also, the second lower-side rib 232 also extends relatively longer from the second lower-side restraining main body portion 231 in the third direction. For example, in comparison with the above-described modifications, the second lower-side rib 232 according to the present embodiment is longer in the third direction. This further improves rigidity of the second lower-side rib 232.

Also, in the present embodiment, the first exhaust valve 111b is formed on the upper face of the first cell case 111 of each of the first cells 110. The second exhaust valve 211b is formed on the upper face of the second cell case 211 of each of the second cells 210. The first restraining member 120 and the second restraining member 220 are joined to each other.

In the above configuration, in the abnormal mode, gas inside the first cell case 111 is more readily discharged from the first exhaust valve 111b, and gas inside the second cell case 211 is more readily discharged from the second exhaust valve 211b. This increases the likelihood that debris will scatter on the upper side of the first restraining member 120 and the second restraining member 220. Here, joining the first restraining member 120 and the second restraining member 220 to each other can further suppress debris from coming into contact with the first cell terminal 112 or the second cell terminal 212.

In the above description of the embodiment, configurations that can be combined may be combined with each other.

The embodiment disclosed herein should be considered to be exemplary in all respects and not restrictive. The scope of the present disclosure is defined by the claims rather than by the above description, and is intended to include all modifications that fall within the meaning and scope equivalent to those of the claims.

What is claimed is:

1. A power storage device comprising:
a first battery module; and
a second battery module, wherein
the second battery module is situated in a first direction perpendicular to an up-down direction as viewed from the first battery module,
the first battery module includes a plurality of first cells and a first restraining member,
the first cells are aligned in a second direction that is perpendicular to both the up-down direction and the first direction,
each of the first cells includes a first cell case and a first cell terminal,
the first cell terminal is provided on the first cell case and also faces the second battery module,
the first restraining member is provided on the first cell case of each of the first cells so as to apply a restraining load to the first cells in the second direction,
the second battery module includes a plurality of second cells and a second restraining member,
the second cells are aligned in the second direction,
each of the second cells includes a second cell case and a second cell terminal,
the second cell terminal is provided on the second cell case and also faces the first battery module,
the second restraining member is provided on the second cell case of each of the second cells so as to apply a restraining load to the second cells in the second direction, and
the first restraining member and the second restraining member are connected to each other upward from the first cell terminals of the first cells and also upward from the second cell terminals of the second cells, so as to close off between the first cells and the second cells.

2. The power storage device according to claim 1, wherein
the first restraining member includes a first restraining main body portion and a first rib,
the first restraining main body portion extends along surfaces of the first cell cases of the first cells,
the first rib extends from the first restraining main body portion in parallel to the first direction,
the second restraining member includes a second restraining main body portion and a second rib,
the second restraining main body portion extends along surfaces of the second cell cases of the second cells,
the second rib extends from the second restraining main body portion in parallel to a third direction that is an opposite direction to the first direction, and
the first rib and the second rib are in contact with each other in the up-down direction between the first cells and the second cells.

3. The power storage device according to claim 1, wherein
the first battery module further includes a first lower-side restraining member,
the first lower-side restraining member is provided on the first cell case of each of the first cells so as to apply a restraining load to the first cells in the second direction,
the second battery module further includes a second lower-side restraining member,
the second lower-side restraining member is provided on the second cell case of each of the second cells so as to apply a restraining load to the second cells in the second direction, and
the first lower-side restraining member and the second lower-side restraining member are connected to each other so as to close off between the first cells and the second cells downward from the first cell terminals of the first cells and also downward from the second cell terminals of the second cells.

4. The power storage device according to claim 3, wherein
the first lower-side restraining member includes a first lower-side restraining main body portion and a first lower-side rib,
the first lower-side restraining main body portion extends along the surfaces of the first cell cases of the first cells,
the first lower-side rib extends from the first lower-side restraining main body portion in parallel to the first direction,
the second lower-side restraining member includes a second lower-side restraining main body portion and a second lower-side rib,
the second lower-side restraining main body portion extends along the surfaces of the second cell cases of the second cells,
the second lower-side rib extends from the second lower-side restraining main body portion in parallel to the third direction that is the opposite direction to the first direction, and
the first lower-side rib and the second lower-side rib are in contact with each other in the up-down direction between the first cells and the second cells.

5. The power storage device according to claim 1, wherein
a first exhaust valve is fashioned on an upper face of the first cell case of each of the first cells,
a second exhaust valve is fashioned on an upper face of the second cell case of each of the second cells, and
the first restraining member and the second restraining member are joined to each other.
